(19) United States
(12) Patent Application Publication
(10) Pub. No.: US 2025/0130606 A1
(43) Pub. Date: Apr. 24, 2025

(54) CONFIGURABLE VOLTAGE REGULATOR

(71) Applicant: Raymond CHONG, Bayan Lepas (MY)

(72) Inventor: Raymond CHONG, Bayan Lepas (MY)

(21) Appl. No.: 19/000,748

(22) Filed: Dec. 24, 2024

(51) Int. Cl. G05F 1/575

(52) U.S. Cl. CPC G05F 1/575

(57) ABSTRACT

Disclosed are voltage regulator circuits and techniques. Some embodiments employ an offset induced buffer to drive an N-type drive transistor.

### TECHNICAL FIELD

Embodiments of the invention relate to the field of semiconductor circuits and more particularly to the field of voltage regulator circuits.

### BRIEF DESCRIPTION OF THE DRAWINGS

The disclosure may best be understood by referring to the following description and accompanying drawings that are used to illustrate embodiments of the invention. In the drawings:

FIG. 1 is a diagram showing an example of a conventional N-type LDO design.

FIG. 2 is a block diagram of a voltage regulator with induced offset in accordance with some embodiments.

FIG. 3 is a schematic diagram showing a more detailed programmable voltage regulator with an offset Induced Voltage Buffer in accordance with some embodiments.

FIG. 4 is a schematic diagram showing a programmable voltage regulator with an offset Induced Voltage Buffer in accordance with some additional embodiments.

FIG. 5 is a block diagram illustrating how regulator circuits may be used for different applications in accordance with some embodiments.

FIG. 6 illustrates an example computing system in accordance with some embodiments.

FIG. 7 illustrates a block diagram of an example processor and/or SoC that may have one or more cores and an integrated memory controller in accordance with some embodiments.

FIG. 8 is a block diagram illustrating a computing system 800 configured to implement one or more aspects of the examples described herein.

### DETAILED DESCRIPTION

Voltage regulators such as low-dropout (LDO) regulators are used for generating internal power supplies for integrated circuits (ICs) including field programmable gate array (FPGA) and other IC apparatuses. They are used for a wide array of supply applications within an IC device. For example, they are used to generate stable output voltages for a variety of different interconnect circuits such as for Low Voltage Swing Termination (LVST) logic and MIPI-DPHY Scalable Low Voltage Signaling (e.g., SLVS400) standards, where desired voltage outputs can be at a value anywhere between 400 mV to 600 mV and higher, e.g., for the IO Transmitters.

Such different voltage targets with their associated different load currents make designs for voltage regulators to be challenging, especially when it comes to power and performance. Traditionally, different regulator designs are made for the different output voltage/current use cases to optimize both power and performance for each need, but supporting different implementations can make design and integration more complex and more costly. In addition, even when multiple designs can be tolerated, the need for ever decreasing supply voltage levels makes LDO designs challenging for at least several different reasons. Ideally, low power regulator designs should use low voltage supplies, which limits the available headroom for amplifier signal swings, particularly with NMOS type topologies.

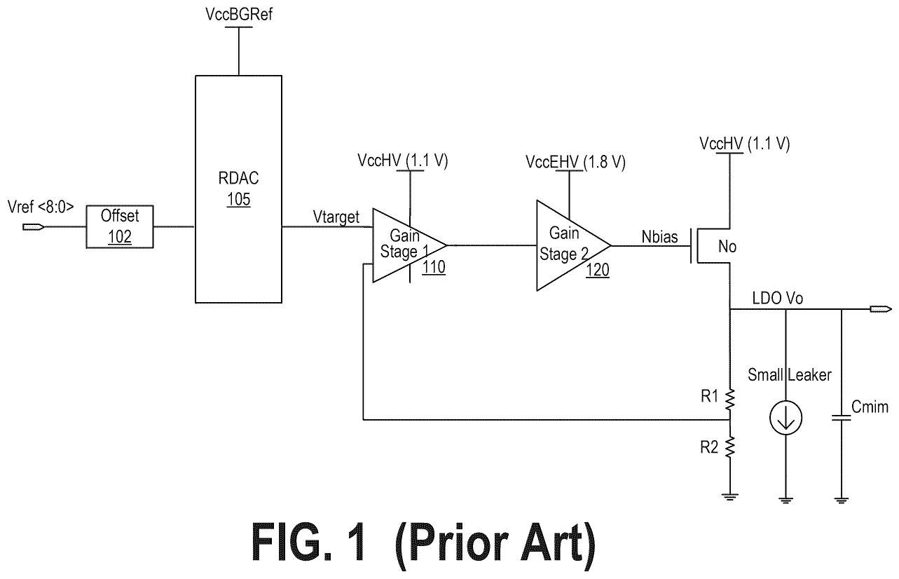

FIG. 1 is a diagram showing an example of a conventional N-type LDO design. At a high level, the voltage regulator is formed from first and second amplifier gain stages, 110, 120, along with an N-type output driver (No), coupled as shown. It also includes a reference digital to analog converter (RDAC) 105 to set a desired target voltage to be regulated, along with output and feedback circuits (R1, R2, small leaker, Cmin) to control and stabilize the regulated output voltage (LDO Vo). With such designs, different voltage targets effectively require different voltage regulator designs to achieve suitable performance for each application. Adjusting the reference voltage works only to a certain extent as it will cause the voltage swing to saturate at one side of the rail, thus degrading the gain of the error amplifier (110).

Moreover, an NMOS (N-type metal oxide semiconductor) pass transistor topology (also referred to as N-type driver topology), as compared with a P-type (PMOS) driver topology, requires a higher rail supply in the amplifier(s) to overdrive the N-type driver transistor by at least 1 threshold voltage (Vt) during high load scenarios. For example, with the depicted regulator, stage 1 uses a 1.1 V (high voltage) supply, while stage 2 uses a 1.8V (extreme high voltage) supply, and the final NMOS pass transistor (Nd) uses the 1.1 V supply. This topology attempts to improve the overall power consumption by using multiple rails, but there are a few drawbacks. The power consumption is reduced but the power wastage is still there because Stage 2 is a second stage gain (greater than unity), which consumes high current, and it uses a high 1.8 V rail. On the other hand, the VccHV rail also needs to be higher than N-type bias feedback levels for the close loop control to work properly. During high load scenarios, this N bias feedback voltage is elevated, which in turn causes the output of stage 1 to go higher as well. If the VccHV supply were lower, then it would run into headroom issues that would degrade the overall gain of the error amplifier. The above issues create a tradeoff between power and performance.

Another issue is that this regulator is designed for a higher voltage target and only for a certain application use case, where the voltage target is about 0.75 V to 0.8 V. This same circuit would not work well with lower voltage targets, e.g., at or below 0.5 V.

Again, IC products such as FPGA ICs are requiring a wider array of different, stable internal voltage supplies and at the same time demanding reduced power consumption, high performance and at a reasonable cost. Accordingly, in some embodiments, configurable voltage regulators are provided that can support a range of voltage targets. Various different features are disclosed that taken alone or together in any suitable combination can result in savings in integration efforts and costs while achieving power savings. For example, in some embodiments, a robust voltage regulator topology is provided that can generate supplies ranging from 0.4 V to 0.75 V and sourcing currents from 0 to 100 mA.

In some embodiments, an induced offset voltage buffer is disposed between the error amplifier and the N-type pass transistor. The voltage buffer serves as a level shifter to elevate the voltage for the gate of the N-type transistor. An offset is placed within the voltage buffer to force the biasing of the error amplifier to be within a desired range, which allows the error amplifier to run at a lower supply, and thus saving power.

Moreover, in some embodiments, the Quiescent point (also referred to as Q-point of the error amplifier) is forced to the center of the supply rail relative to a low supply reference (e.g., ground). This facilitates suitable swing and gain of the amplifier, even if it is running at a low voltage supply, which also saves power. In some embodiments, this may be achieved through calibration and/or by using a low bandwidth close loop to control the Q-point.

In some embodiments, voltage regulators may be configurable such that the power and performance can be tuned for each application. For example, biasing reference current, a feedback divider, a leaker current, a Miller zeros compensation, or any combination thereof may be programmable to provide flexibility for users to provide a robust design, fitting a wide array of different scenarios.

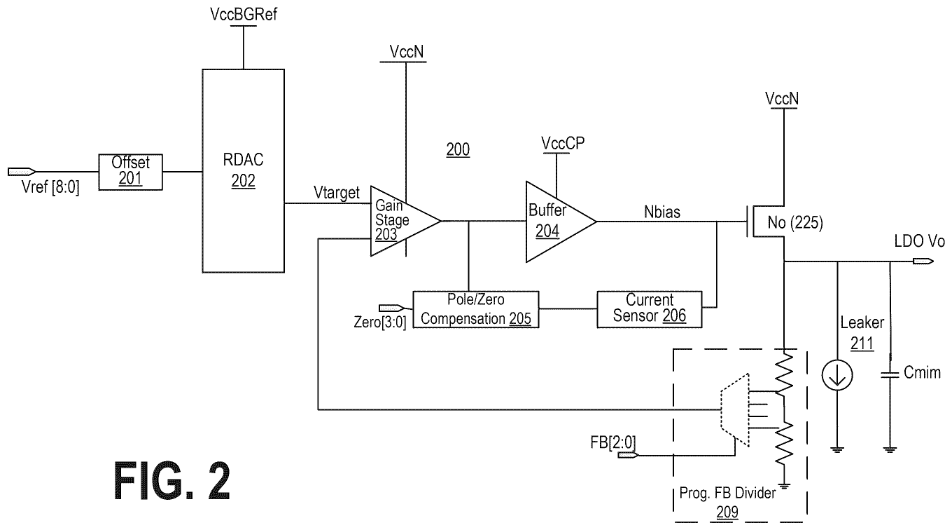

FIG. 2 is a block diagram of a voltage regulator with induced offset in accordance with some embodiments. The depicted regulator includes a reference generating DAC 202, with an associated offset adjustment circuit 201, an error amplifier with gain 203, an offset inducing buffer circuit 204, an N-type pass transistor (output driver No) 215, a current sensor 206, a pole-zero compensation circuit 205, and a programmable feedback divider circuit 209, coupled together as shown. The regulator also includes a leaker 211 and an output capacitance (Cmin).

The RDAC 202, in concert with the offset circuit 201, generates an analog reference voltage based on an input digital reference code (Vref), 8 bit code in this example. The reference voltage is applied to one of the differential inputs of gain amplifier stage 203. The differential amplifier 203 has sufficient gain to provide a reduced differential offset and to facilitate sufficient headroom given that the gain stage uses a VccN rail, which in some embodiments, may range from 0.9 V to 1.1 V.

The voltage buffer 204 (e.g., offset induced voltage buffer) is coupled to the output of the gain stage 203. Among other things, the voltage buffer 204 serves as a shield between the Gain Stage 203 and the N-type driver (pass transistor) 225 to achieve enhanced transient behavior and stability as the gate capacitance for the N-type driver is usually large. In addition, in some embodiments, the voltage buffer 204 may also act as a level shifter to elevate the gain stage 203 output for over-driving the N-type driver 225.

The current sensor 206 and pole-zero compensation (also referred to as adaptive zero compensation) circuit 205 not only provides closed loop feedback to voltage buffer 204, but also, they facilitate pole-zero tuning for the regulator to be stable and also sufficiently responsive. The N-type output driver (No) 225 drives load current from the VccN rail (as opposed to a higher supply, e.g., VccCP) to improve power efficiency of the voltage regulator. The output voltage feedback goes through the programmable resistor divider 209 to set a suitable common mode for the differential amplifier 203.

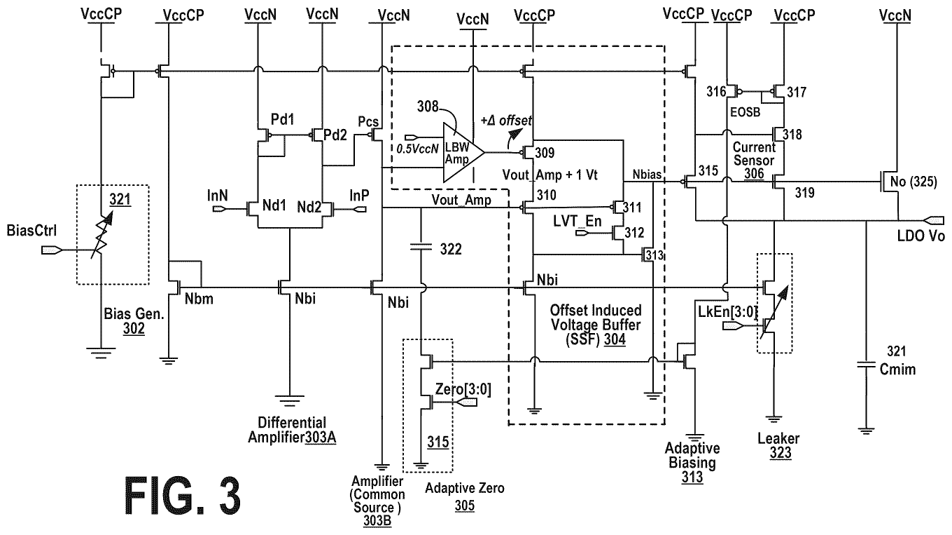

FIG. 3 is a schematic diagram showing a more detailed programmable voltage regulator with an offset Induced Voltage Buffer in accordance with some embodiments. This regulator circuit, for the most part, includes the blocks from the regulator of FIG. 2, along with some additional circuit blocks to implement functions of the blocks of FIG. 2 and/or to perform other functions.

Much of the circuit blocks utilize a common bias current that is generated from a bias generation circuit 302. Bias generation circuit 302 includes a variable current source resistor 321 and mirroring transistors (Nm, Nbi). The generated bias current is controlled through the programmable resistor 321 from a control input (BiasCtrl) to configure the reference current used by much of the voltage regulator. In some embodiments, the bias current is used to tune the overall power and performance of the voltage regulator. The generated reference current is copied through a current mirror transistor (Nm) to appropriately weighted feeder transistors (Nbi) to provide bias current to a differential amplifier 303A, a common source amplifier 303B, and an offset induced voltage buffer 304. (Note that in the depicted embodiment of FIG. 3, a gain error amplifier stage (or error amplifier with gain), such as 203 from FIG. 2, is formed from a differential error amplifier circuit 303A and a gain generating common source circuit 303B, as shown. However, an error amplifier with gain may be implemented using any suitable circuit configuration, e.g., a differential amplifier with inherently suitable gain and drive characteristics.)

The programmable bias current provides a user with the flexibility to tune power and performance for the voltage regulator. The current mirror uses the VccCP supply, which in some embodiments, is a 1.5 V charge pump rail. While any suitable supply level and/or source may be used, the charge pump may be used because it is relatively quiet and reasonably stable.

The differential amplifier 303A and common source amplifier 303B, together form a two-pole gain stage. Such a gain stage may achieve a sufficiently high gain, e.g., above 40 dB, allowing the differential DC offset to be reasonably low. The differential amplifier 303A uses N-type input transistors, while the common source amplifier 303B uses a P-type transistor (Pcs) to provide sufficient headroom because the devices, with the depicted example, are biased in the saturation region.

The differential amplifier 303A has first and second inputs, In_P and In_N. The In_P input receives the reference voltage input (e.g., from RDAC 202), while the In_N receives the close loop feedback from the regulator output (LDO Vo), the connection not being expressly shown. The gain stage uses the VccN supply rail, which in some embodiments, is at a value in a range from 0.9 V to 1.1 V. It should be appreciated that this is reasonably low, saving power and at the same time, with the circuit configuration, facilitating sufficient headroom.

The output of the gain stage 303 (from common source amplifier 303B) is coupled to the offset induced voltage buffer 304, shielding between the gain stage 303 and the N-type driver (a.k.a., pass) transistor 325 (No) to achieve better transient behavior and stability as the gate capacitance for the N-type driver is usually relatively large. In the depicted example, the voltage buffer 304 also acts as a level shifter to elevate the gain stage output to overdrive the N-type driver 325.

However, the buffer stage, voltage buffer 304, introduces another pole which would impact the stability of the close loop system if not considered. Therefore, the voltage buffer is configured to include a high frequency pole with low output impedance. Such a voltage buffer may be implemented with a super source follower (SSF). With this example, it is formed using devices 310-313. It is configured so that the additional pole has a higher frequency than the gain bandwidth (e.g., unit gain-bandwidth) of the close loop to not adversely affect the stability of the close loop system. As mentioned, the voltage buffer also works as a level shifter and thus, the biasing points for the input and output of the voltage buffer 304 should be appropriately selected. For example, if the Nbias node (at the input of transistor 315) is required to be increased in the event of high load current, the input of the voltage buffer (Vout_Amp) should also go higher. If not considered, this could cause a potential risk to the gain stage 303, where the signal may swing to one side of the rail because the gain stage is using a lower voltage supply. On the other hand, in the event of low load current or low voltage targets (e.g., below 0.5 V), the Nbias voltage may shift down, causing Vout_Amp to shift even further down, close to the low supply reference (e.g., Vss). In both cases, the headroom margin would be subsumed, causing a degradation on the gain of the amplifier 303.

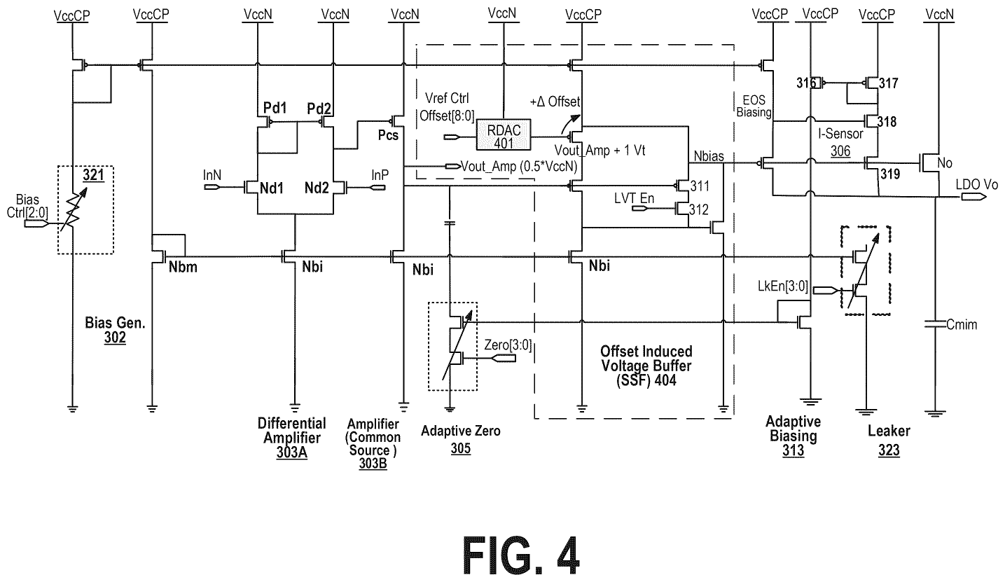

Accordingly, in some embodiments, the voltage buffer 304 incorporates an offset inducing feature where the biasing points may be self-calibrated such that the Q-point is closer to the center of VccN to increase headroom and gain. The offset can be induced in any suitable way. For example, with reference to FIG. 3, one way is for P-type device 309 to be biased by a low bandwidth amplifier 308. Another way, with reference to FIG. 4, is for transistor 309 to be biased by a lower power reference DAC (RDAC) 401.

The low bandwidth amplifier 308 uses a 0.5*VccN bias as a reference input to adjust the DC level of the Vout_Amp signal by regulating the gate of the P-type transistor 309. The amplifier 308 uses a sufficiently low bandwidth amplifier to avoid jeopardizing the stability of the main loop in the voltage regulator. The P-type device 309 essentially creates an offset to the voltage buffer 304 such that the Nbias node behaves in accordance with a function: Vout_Amp+Vt+Offset. This offset causes Vout_Amp to stay close to 0.5*VccN. The Nbias node is regulated by the close loop system to overdrive the N-type driver 325 to drive a given load current and voltage target. The regulation of Nbias also regulates the P-type transistor 309 Offset, since Vout_Amp and Vt are fixed.

Alternatively, the gate of the P-type transistor 309 can also be driven by the programmable resistor DAC 401, as shown in FIG. 4, to accomplish the same end. However, this method may require extra calibration, e.g., through a Firmware to train the offset values.

In some embodiments, a low voltage target circuit (311, 312) is included for enhanced lower output voltage operation. For example, When the voltage output target is set lower than 0.5 V, the separate low voltage transistor 311 bypass can be enabled through 312 using a low voltage enable (LVT_En) signal. In this way, the offset can be bypassed with stronger and less resistive input devices (e.g., 311).

The depicted example also includes pole-zero compensation and current sensor circuits 305, 306, respectively. Despite the controlled Q-point, the poles and zeroes of the close loop system should be handled carefully. The exemplary regulator circuit has four poles. The lowest frequency pole, or the dominant pole, is at the output of the LDO (LDO Vo), while the Gain Stage 303 has two poles, followed by the high frequency poles in the voltage buffer 304. The output pole is set to be dominant with a large capacitor (Cmin) at the output. To achieve a sufficiently stable close loop system, the phase margin should be greater than 45 degrees, which would typically allow for a 2-pole system. Any additional pole within the unity-gain bandwidth should be subdued. Hence, a Zero in the pole-zero (also referred to as adaptive zero) compensation circuit 305 is used to compensate for the Vout_Amp pole. The zero is provided using the capacitor 322 with a variable strength, programmable transistor 315, e.g., with selectable parallel transistor legs. The adaptive zero is also controlled by an adaptive biasing circuit 313 with mirroring transistors 316-319 from the current sensor 306.

In the event of high load current, the output pole shifts to a higher frequency that would lead to a less stable system. However, with this circuit, the Nbias node is also shifted up, producing higher current in the current mirror and hence higher biasing voltage for the adaptive-zero circuit 305. In turn, the RC from the adaptive zero 306 and the capacitor 322 counter the pole of the Vout_Amp.

Similarly, when the output load current decreases, the opposite happens, where the adaptive zero 306 circuit becomes more resistive and lower capacitance is seen by Vout_Amp. This adaptive nature results in the close loop system being stable across varying load currents, and it also maintains the desired quiescent current for the voltage regulator even with low load power scenarios.

Finally, The N-type output driver (No) 325 drives load current from the VccN rail, which improves power efficiency of the voltage regulator. The output (LDO Vo) goes through a programmable resistor voltage divider (e.g., 209 from FIG. 2) to adjust an optimal common mode for the differential amplifier 303A.

FIG. 4 is a schematic diagram showing a programmable voltage regulator with an offset Induced Voltage Buffer in accordance with some additional embodiments. This example is similar to the regulator of FIG. 3, apart from how its offset induced voltage buffer 404 is implemented. With this example, transistor 309 is biased using a low-power reference DAC (RDAC) 401 to induce the offset. In some embodiments, this approach may require calibration, e.g., through a Firmware to tune the offset values.

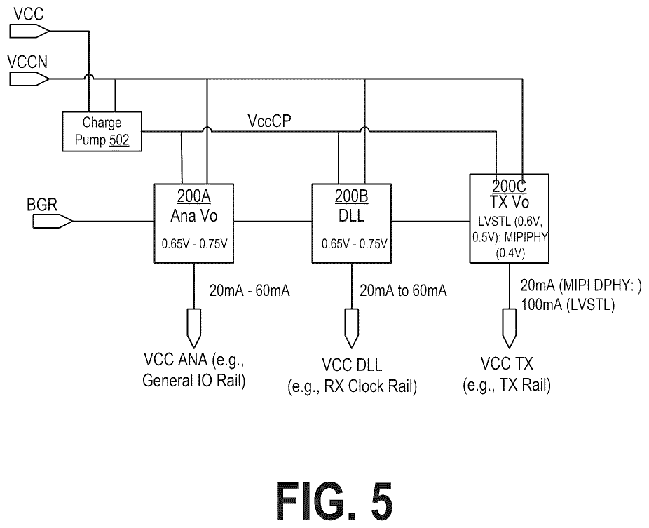

FIG. 5 is a block diagram illustrating how regulator circuits may be used for different applications in accordance with some embodiments. The circuit includes first and second voltage rails, Vcc and VccN, along with a charge pump circuit 502 to generate a VccCP supply off of the Vcc and/or VccN supplies. The VccN and VccCP rails may be used, as discussed above, with regulators 200 (200A, 200B, and 200C) of a common design to generate different output supplies for different applications. In some embodiments, the VccN rail may be at a value ranging from 0.9 V to 1.188 V, and the VccCP rail may be at a value near 1.5 V (e.g., a value ranging from between 1.2 and 1.8 or higher V).

With this example, the regulated voltages are used for various different interconnect supplies, e.g., for different transmitter (Tx) and/or receiver (Rx) functions. Regulator 200A is used to generate an analog supply at a value in a range from between 600 mV and 750 mV. Regulator 200B is used to generate a DLL (delay locked loop) supply value in a range from 650mV to 750-mV. Finally, regulator 200C is used to generate Tx supplies, e.g., for MIPI-DPHY or LVSTL circuits at supplies in a range from 400 mV to 600 mV. While the circuits may be configured differently, they may be implemented with fundamentally similar circuit blocks, as described above, allowing for more efficient implementation in IC products while delivering reliable, power efficient solutions.

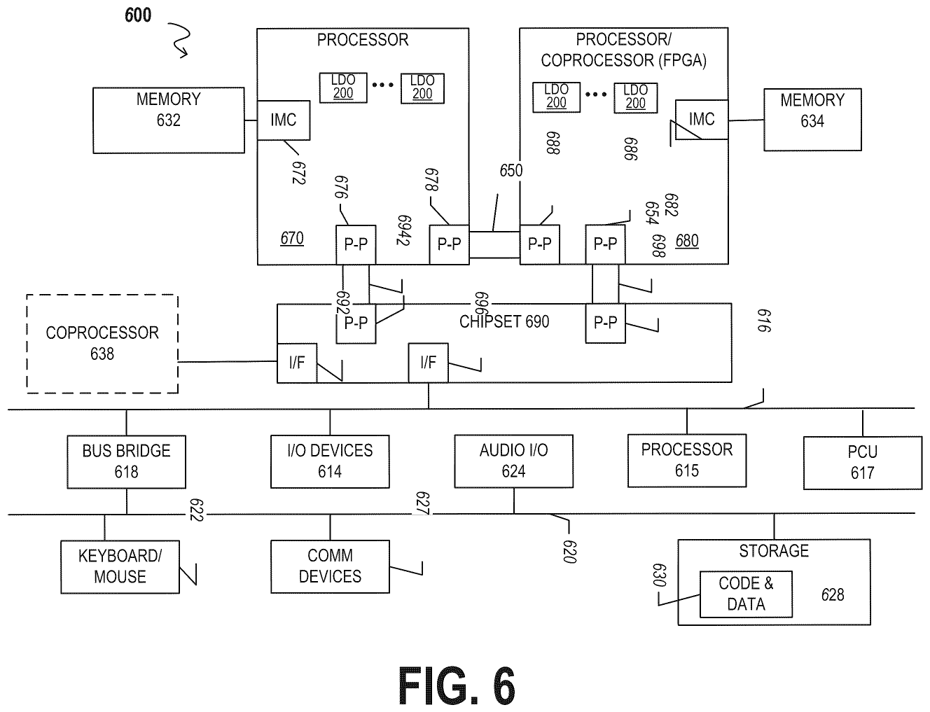

FIG. 6 illustrates an example computing system. Multiprocessor system 600 is an interfaced system and includes a plurality of processors including a first processor 670 and a second processor 680 coupled via an interface 650 such as a point-to-point (P-P) interconnect, a fabric, and/or bus. Either or both processors include a plurality of voltage regulator circuit 200 as described herein. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 670 and 680 are shown including integrated memory controller (IMC) circuitry 672 and 682, respectively. Processor 670 also includes interface circuits 676 and 678, along with core sets. Similarly, second processor 680 includes interface circuits 686 and 688, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may cach exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipsct) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect, or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to one or more voltage regulators (not shown) to cause the voltage regulator(s) to generate the appropriate regulated voltage(s). PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

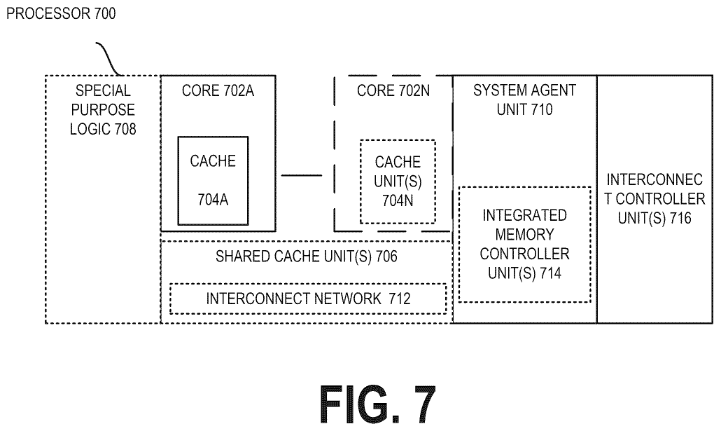

FIG. 7 illustrates a block diagram of an example processor and/or SoC 700 that may have one or more cores and an integrated memory controller. The solid lined boxes illustrate a processor and/or SoC 700 with a single core 702(A), system agent unit circuitry 710, and a set of one or more interface controller unit(s) circuitry 716, while the optional addition of the dashed lined boxes illustrates an alternative processor and/or SoC 700 with multiple cores 702(A)-(N), a set of one or more integrated memory controller unit(s) circuitry 714 in the system agent unit circuitry 710, and special purpose logic 708, as well as a set of one or more interface controller unit(s) circuitry 716. Note that the processor and/or SoC 700 may be one of the processors 670 or 680, or co-processor 638 or 615 of FIG. 6.

Thus, different implementations of the processor and/or SoC 700 may include: 1) a CPU with the special purpose logic 708 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 702(A)-(N) being one or more general purpose cores (e.g., general purpose in-order cores, general purpose out-of-order cores, or a combination of the two); 2) a co-processor with the cores 702(A)-(N) being a large number of special purpose cores intended primarily for graphics and/or scientific (throughput); and 3) a co-processor with the cores 702(A)-(N) being a large number of general purpose in-order cores. Thus, the processor and/or SoC 700 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit(s) circuitry 716 couple the cores 702(A)-(N) to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

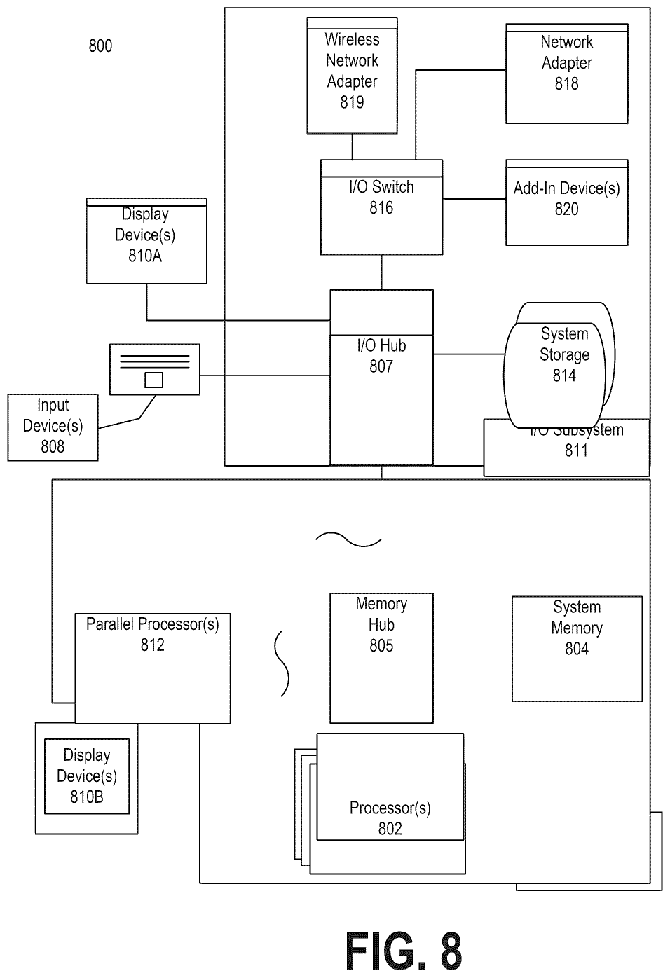

FIG. 8 is a block diagram illustrating a computing system 800 configured to implement one or more aspects of the examples described herein. The computing system 800 includes a processing subsystem 801 having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link 806. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or communication link 813. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMc.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8. For example, the memory hub 805 may be referred to as a Northbridge in some architectures, while the I/O hub 807 may be referred to as a Southbridge.
Illustrative examples of the technologies disclosed herein are provided below. An embodiment of the technologies may include any one or more, and any compatible combination of, the examples described below.

Example 1 is a voltage regulator circuit that includes an error amplifier, an offset induced voltage buffer, and an N-type output driver. The error amplifier has a gain that is greater than unity. The N-type output driver is to provide a regulated output voltage. The offset induced voltage buffer is coupled between the error amplifier and the output driver.

Example 2 includes the subject matter of example 1, and wherein the offset induced voltage buffer is to level shift the error amplifier upward for driving the N-type output driver.

Example 3 includes the subject matter of any of examples 1-2, and wherein the offset induced voltage buffer includes a super source follower circuit.

Example 4 includes the subject matter of any of examples 1-3, and wherein the offset induced voltage buffer includes a P-type transistor with an input that is coupled to a bias amplifier to induce an offset into the voltage buffer.

Example 5 includes the subject matter of any of examples 1-4, and wherein the bias amplifier includes a first input coupled to the P-type transistor and a second input coupled to an offset voltage reference.

Example 6 includes the subject matter of any of examples 1-5, and wherein the offset voltage reference is one-half of a voltage supply provided to the bias amplifier.

Example 7 includes the subject matter of any of examples 1-6, and wherein the offset induced voltage buffer includes a P-type transistor with an input that is coupled to a voltage reference generation circuit to bias it and induce an offset into the voltage buffer.

Example 8 includes the subject matter of any of examples 1-7, and wherein the error amplifier and N-type output driver cach include one or more first supply nodes coupled to a first supply rail, and the offset induced voltage buffer includes a second supply node coupled to a second supply rail, wherein the first supply rail is to supply a lower voltage than the second supply rail.

Example 9 includes the subject matter of any of examples 1-8, and wherein the error amplifier includes a differential amplifier and a common source amplifier.

Example 10 includes the subject matter of any of examples 1-9, and wherein the common source amplifier includes a P-type transistor, and the error amplifier has a gain that is greater or equal to 40 dB.

Example 11 includes the subject matter of any of examples 1-10, and wherein the offset induced voltage buffer includes a feedback circuit with a pole-zero compensation circuit.

Example 12 includes the subject matter of any of examples 1-11, and wherein the feedback circuit includes a current sensor coupled in series between the pole-zero compensation circuit and an output of the offset inducing voltage buffer.

Example 13 includes the subject matter of any of examples 1-12, and comprising a bypass transistor coupled to the N-type output driver for a low output voltage mode.

Example 14 is an integrated circuit apparatus that includes first and second supply rails and a plurality of voltage regulators. The first supply rail is to provide a first supply voltage. The second supply rail is to provide a second supply voltage, wherein the second supply voltage is higher than the first supply voltage. The plurality of voltage regulators each include a differential amplifier, a buffer, an output drive transistor, and an adaptive zero compensation circuit. The differential amplifier includes a differential amplifier supply node coupled to the first supply rail and a differential amplifier output node. The voltage buffer includes (i) a buffer input node that is coupled to the differential amplifier output node, (ii) a buffer supply node that is coupled to the second supply rail, and (iii) a buffer output node. The output drive transistor includes (i) a drive transistor input coupled to the buffer output node, and a drive transistor supply node coupled to the first supply rail. The adaptive zero compensation circuit is coupled between the buffer input and buffer output nodes.

Example 15 includes the subject matter of example 14, and wherein the voltage buffer is to level shift upward from the buffer input node to the buffer output node.

Example 16 includes the subject matter of any of examples 14-15, and wherein the voltage buffer includes a super source follower circuit.

Example 17 includes the subject matter of any of examples 14-16, and wherein the voltage buffer includes a P-type transistor with an input that is coupled to a bias amplifier to induce an offset into the voltage buffer.

Example 18 includes the subject matter of any of examples 14-17, and wherein the voltage buffer includes a P-type transistor with an input that is coupled to a voltage reference generation circuit to bias it and induce an offset into the voltage buffer.

Example 19 is a system that includes a processor, memory, and an FPGA apparatus. The memory is coupled to the processor. The FPGA includes one or more voltage regulator circuits that include an error amplifier, an output driver, and an offset induced voltage buffer. The error amplifier has a gain that is greater than unity. The output driver is to provide a regulated output voltage. The offset induced voltage buffer is coupled between the error amplifier and the output driver.

Example 20 includes the subject matter of example 19, and wherein the offset induced voltage buffer is to level shift the error amplifier upward for driving the N-type output driver.

Example 21 includes the subject matter of any of examples 19-20, and wherein the offset induced voltage buffer includes a super source follower circuit.

Example 22 includes the subject matter of any of examples 19-21, and wherein the offset induced voltage buffer includes a P-type transistor with an input that is coupled to a bias amplifier to induce an offset into the voltage buffer.

Example 23 includes the subject matter of any of examples 19-22, and wherein the bias amplifier includes a first input coupled to the P-type transistor and a second input coupled to an offset voltage reference.

Example 24 includes the subject matter of any of examples 19-23, and wherein the offset voltage reference is one-half of a voltage supply provided to the bias amplifier.

Example 25 includes the subject matter of any of examples 19-24, and wherein the offset induced voltage buffer includes a P-type transistor with an input that is coupled to a voltage reference generation circuit to bias it and induce an offset into the voltage buffer.

Example 26 includes the subject matter of any of examples 19-25, and wherein the error amplifier and N-type output driver each include one or more first supply nodes coupled to a first supply rail, and the offset induced voltage buffer includes a second supply node coupled to a second supply rail, wherein the first supply rail is to supply a lower voltage than the second supply rail.

Example 27 includes the subject matter of any of examples 19-26, and wherein the error amplifier includes a differential amplifier and a common source amplifier.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FcFET) transistors.

In the drawings of the embodiments, signals are represented with lines. Some lines may appear different from others, for example, thicker or hatched, to distinguish from other depicted signals for ease of understanding. Along these lines, some signal lines may have arrows at one or more ends, to indicate a primary direction of information flow. However, such indications are not intended to be limiting. Rather, lines are used in connection with one or more exemplary embodiments in a given figure to facilitate easier understanding of concepts embodied in block, circuit, and/or flow diagrams. Any represented signal, as dictated by design needs or preferences, may actually comprise one or more signals that may travel in either direction and may be implemented with any suitable type of signal scheme, e.g., analog, digital, wired, wireless, upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that a processor or processor system may be implemented in various different manners. For example, they may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A voltage regulator circuit, comprising:
an error amplifier with a gain that is greater than unity;
an N-type output driver to provide a regulated output voltage; and
an offset induced voltage buffer coupled between the error amplifier and the output driver.

2. The circuit of claim 1, wherein the offset induced voltage buffer is to level shift the error amplifier upward for driving the N-type output driver.

3. The circuit of claim 1, wherein the offset induced voltage buffer includes a super source follower circuit.

4. The circuit of claim 1, wherein the offset induced voltage buffer includes a P-type transistor with an input that is coupled to a bias amplifier to induce an offset for the voltage buffer.

5. The circuit of claim 4, wherein the bias amplifier includes a first input coupled to the P-type transistor and a second input coupled to an offset voltage reference.

6. The circuit of claim 5, wherein the offset voltage reference is one-half of a voltage supply provided to the bias amplifier.

7. The circuit of claim 1, wherein the offset induced voltage buffer includes a P-type transistor with an input that is coupled to a voltage reference generation circuit to bias it and induce an offset for the voltage buffer.

8. The circuit of claim 1, wherein the error amplifier and N-type output driver each include one or more first supply nodes coupled to a first supply rail, and the offset induced voltage buffer includes a second supply node coupled to a second supply rail, wherein the first supply rail is to supply a lower voltage than the second supply rail.

9. The circuit of claim 1, wherein the error amplifier includes a differential amplifier and a common source amplifier.

10. The circuit of claim 9, wherein the common source amplifier includes a P-type transistor, and the error amplifier has a gain that is greater or equal to 40 dB.

11. The circuit of claim 1, wherein the offset induced voltage buffer includes a feedback circuit with an adaptive zero compensation circuit.

12. The circuit of claim 11, wherein the feedback circuit includes a current sensor coupled in series between the adaptive zero compensation circuit and an output of the offset inducing voltage buffer.

13. The circuit of claim 1, comprising a bypass transistor coupled to the N-type output driver for a low output voltage mode.

14. An integrated circuit apparatus, comprising:
a first supply rail to provide a first supply voltage;
a second supply rail to provide a second supply voltage, wherein the second supply voltage is higher than the first supply voltage; and
a plurality of voltage regulators that include:
a differential amplifier with a differential amplifier supply node coupled to the first supply rail and a differential amplifier output node;
a voltage buffer with (i) a buffer input node that is coupled to the differential amplifier output node, (ii) a buffer supply node that is coupled to the second supply rail, and (iii) a buffer output node;
an output drive transistor with (i) a drive transistor input coupled to the buffer output node, and a drive transistor supply node coupled to the first supply rail, and
an adaptive zero compensation circuit coupled between the buffer input and buffer output nodes.

15. The apparatus of claim 14, wherein the voltage buffer is to level shift upward from the buffer input node to the buffer output node.

16. The apparatus of claim 14, wherein the voltage buffer includes a super source follower circuit.

17. The apparatus of claim 16, wherein the voltage buffer includes a P-type transistor with an input that is coupled to a bias amplifier to induce an offset into the voltage buffer.

18. The circuit of claim 14, wherein the voltage buffer includes a P-type transistor with an input that is coupled to a voltage reference generation circuit to bias it and induce an offset into the voltage buffer.

19. A system, comprising:
a processor;
memory coupled to the processor; and
a field programmable gate array (FPGA) apparatus coupled to the processor, the FPGA including one or more voltage regulator circuits including:
an error amplifier with a gain that is greater than unity;
an output driver to provide a regulated output voltage; and
an offset induced voltage buffer coupled between the error amplifier and the output driver.

20. The system of claim 19, wherein the offset induced voltage buffer is to level shift the error amplifier upward for driving the N-type output driver.
